(19) United States
(12) Patent Application Publication
(10) Pub. No.: US 2021/0042867 A1
(43) Pub. Date: Feb. 11, 2021

(54) System, Method and computer program product for evaluating admissions related data and compute comprehensible scores for further determination, evaluation, and conclusion of applicant-fit in a college or university system.

(71) Applicant: Arya Deepak Keni, Woodbridge, NJ (US)

(72) Inventor: Arya Deepak Keni, Woodbridge, NJ (US)

(73) Assignee: Arya Deepak Keni, Woodbridge, NJ (US)

(21) Appl. No.: 16/537,583

(22) Filed: Aug. 11, 2019

(51) Int. Cl. G06Q 50/20; G06F 16/906; G06F 16/9035; G06F 16/9032

(52) U.S. Cl. CPC G06Q 50/2053; G06F 16/90332; G06F 16/9035; G06F 16/906

(57) ABSTRACT

This patent discloses methods, systems, and a computer program product for remote analysis of multiple higher-education based factors and other applicant submitted data in undergraduate college admissions processes from a mobile (such as smartphones or tablets) or non-mobile device such as a computer, both of which utilize a data network to fine-tune decisions, along with user input data and previous behavior patterns in admissions processes. The methods and systems use primary and secondary data in real time to compute, evaluate and communicate the final result, an indicative scorecard to aid in further evaluation of the admissions committee regarding one or a set of applicants in the pool.

### RELATED APPLICATIONS

Detecting disability and ensuring fairness in automated scoring of video interviews

Automated distributed screening of job candidates

### BACKGROUND & FIELD OF THE INVENTION

### Field of the Invention

The System, Method and computer program serves to simplify research and processes in college admissions process for the Undergraduate Level specifically by a provision of a single-tool (as discussed in claims) evaluation software for quick computation of ‘understandable numerical boundaries and ranges’ and relevant processes on situations regarding individual or group admissions in college. A prospective link and method of communication via a data network of this computer program product with previous years' admissions data and decisions on each applicant, along with general behavioural and miscellaneous data from third parties like attitude towards admissions each year, public stigma's about admissions each year, and number of common colleges applied to in the past year would provide effective sources and databases for remote computations of each admissions profile to a college via manually controlled devices and processes.

### Background of the Invention

In the recent years, the importance of college and getting a degree for a future job or prospective opportunities has skyrocketed at an unprecedented rate which has caused a spike in the number of applicants for each college across the United States, and the world. For a really small committee assigned to choose which increasingly smaller percent of students with many different talents are offered a chance to attend the college has also been getting increasingly hard, given that human behaviour in essays for applications, human emotions and stories shared in interviews, and the unlimited number of different accomplishments, experiences and circumstances is varied and complex, with increase in the number of such entries due to educational importance.

College Admissions Committees have limited time to make tough decisions for filling in limited and (more or less) set number of seats with an increasingly competitive pool of intelligent, vibrant, and overall excellent students. Admissions processes now rely on subjective methodology of peer review and human reading of applicant profiles (the numerical part such as grades and test scores, and non-numerical parts such as extracurriculars and essays) to make final decision involving many layers of screening to arrive to a conclusion of the best-fit set of accepted applicants.

College Admissions Committees are many times unaware of the complex thought process of the applicant while creating the applicant profile and its dataset, along with other third party features affecting applicants such as public opinion on colleges, rumors and so on. These dilemmas can be quickly and efficiently solved with this computational computer program product to avoid confusion, provide additional data, and add layers of comprehensibility when making these decisions.

### SUMMARY

### Brief Summary of the Invention

To bring more consistency to initial selection/filtration process, complex quantitative-algorithms and systems/technology can be developed to find best applicants for right courses in university.

Vast amounts of qualitative (including passions/interests/aptitude) and quantitative admissions data can be used to fine-tune outcomes through Natural-Language-Processing, Machine-Learning and Predictive-Analytics; reducing human subjectivity and creating an indicative pre-evaluation ‘scorecard’ (CASPER: Candidate-Acceptance-Scorecard-Predictive-Evaluation-Report) for both Admission-Committee and students. Universities can share a version of this scorecard (CASPER: ‘Friendly-Ghost’) for students to get predictive scores on acceptance probability.

The present invention incorporates a number of known technologies into a novel system for making admissions based determinations. More particularly, embodiments of the present invention use a mobile application client (an “App”) and ability for the mobile application client or non-mobile application client to perform search or calculations and communicate with other admissions related news, sources, or related data existing over the internet over a data communications network.

These components are effectively accessible by the bundling algorithm, causing multiple such facets of specific code-language classes accessible under one domain. With button and click functionalities, recording inputs and switching between components is made extremely simple.

This bundle-functionality domain is accessible with and without internet application, in the form a web-computational tool online and in the form of a scientific application (downloadable) offline and send or receive data over a data network to other users, systems or hardware.

The method of data-processing in the bundle-functionality will be described in detail in the later sections. The method generally entails the way in which the computer program product will ‘flow’ the data through the program, giving the desired output.

The motive for transparency in the college admissions processes is furthered by a sharing service of partial CASPER (comprehensive file) results (to protect the complete admissions status based intentions) for the following user-end-efficiency protocols:
1. Withdrawing or continuing applications to the college in question based on the shared data and its result in its full context, to allow other applicants more time for consideration, and more depth based evaluation.
2. Giving a similar report for related conglomerates of higher education institutions.
3. Enabling knowledge about the stance of the applicant for this college in particular, based on its personal importance (tallying college interests in an applicant with applicant evaluated scores and entries with college pre-set and chosen weightages on certain aspects in the applicant file).

The invention's computer program product consists of software with 7 components which can be further extended for providing more related functions and features:
1. A consolidating functionality which imports all data possible related to admissions into the main F algorithm for the most accurate decision process.
2. A set of separate cloud storage services for storage of external, internal, suggestive, and semi-processed data all for quick and easy identifier-based access at any invoking processes in the start to finish run.
3. Functionalities to perform value-based crunching and assignments to abstract phrases and datasets in context of external information.
4. A set of functionalities to distribute, bucket, and assign semi-processed values, and values for continuing the workflow and making further evaluation easier and adhering to complex mathematical functions.
5. Private databases of additional admissions material ready for linkage and for a more comprehensive result.
6. A single dimensional fluid function service for pre-CASPER values and initial crunching (in the Φ function, see FIG. 4.).
7. A multidimensional switch-amplified fluid function service (the Δ to Σ function, see FIG. 4.), to synthesize human like deterministic approaches to final CASPER based categorizing.

### BRIEF DESCRIPTION OF DRAWINGS

FIG. 1: The inputs and sources of the software system leading to the actual CASPER report output, as well as the flow of information in and out of the system as a general scheme.

FIG. 2: The subtasks of the F algorithm, with its described intricacies of flow of classification of inputs and it's separate processing to lead to a set of processed and compiled data.

FIG. 3: The complete module of the computer program product wherein a final verdict is arrived at.

### SPECIFICATIONS—DETAILED DESCRIPTION

A comprehensive set and subset of specific and delicate functionalities is paramount for the perfect workflow of the CASPER system. Data flows from beginning to end, using various other sources, inputs, suggestions along the way to produce the ultimate desired result.

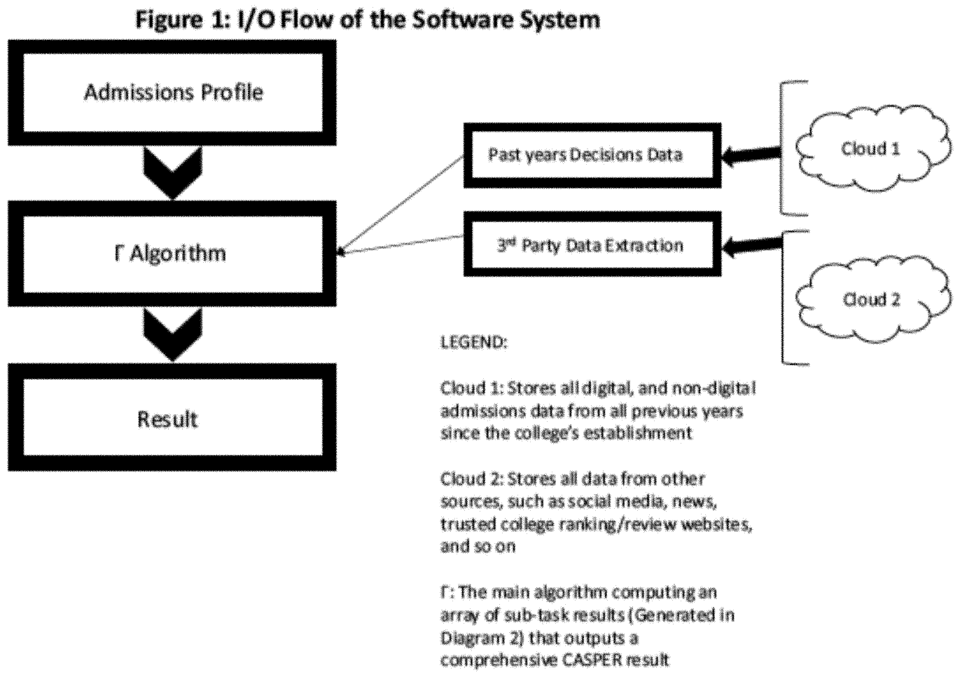

Referencing FIG. 1: The flowchart depicts the processing of data from human input, to program generated output, along with general external servers/linkages.

Referencing FIG. 1: The admissions committee clicks an ‘IMPORT’ button which imports the complete pool of admissions files (as digitized copies in all supported file formats, like .pdf for essays, extracurriculars, test scores, report cards, letter of recommendations, .mp4 for music related entries, .jpg/.png/.jpeg for visual entries in any field) into the F algorithm in a linear fashion for evaluation by breakdowns of each component submitted for the final comprehensive CASPER score result.

Referencing FIG. 1: To supplement additional sources of data for a more accurate output in context of the full year's admissions cycle, past years admissions decisions data, already digitized, or made digital (since the applications before the 1990's or so were all paper) by a scan and Text Recognition System (A standard CTC Decoding Algorithm), and data from Social media, news, trusted college blogs/review/ranking pages will be inputted as an accessible object used after all of the admissions profile data has been processed for adjustments to the Pre-CASPER score.

Referencing FIG. 1: The data in addition to the admissions profile of each student is stored in separate end-to-end encrypted cloud services with only 1 port of access: the special key (the admissions profile number) to utilize the existing data (in form of all supported file formats which will be deciphered for image related data, and extracted to apply relevant data to the applicants profile by running the Base 1 NLP feature).

Referencing FIG. 1: The final CASPER score result, comprising of a common aptitude number, aptitude numbers specific to candidate selected majors, level of excellence in skills/traits that are preset by the college admissions committee (such as perseverance, computer-related skill, and so on) will be outputted. A common statistical analysis will then be performed on these set of numbers per candidate, which would provide quartiles, stacking by range of scores, and so on.

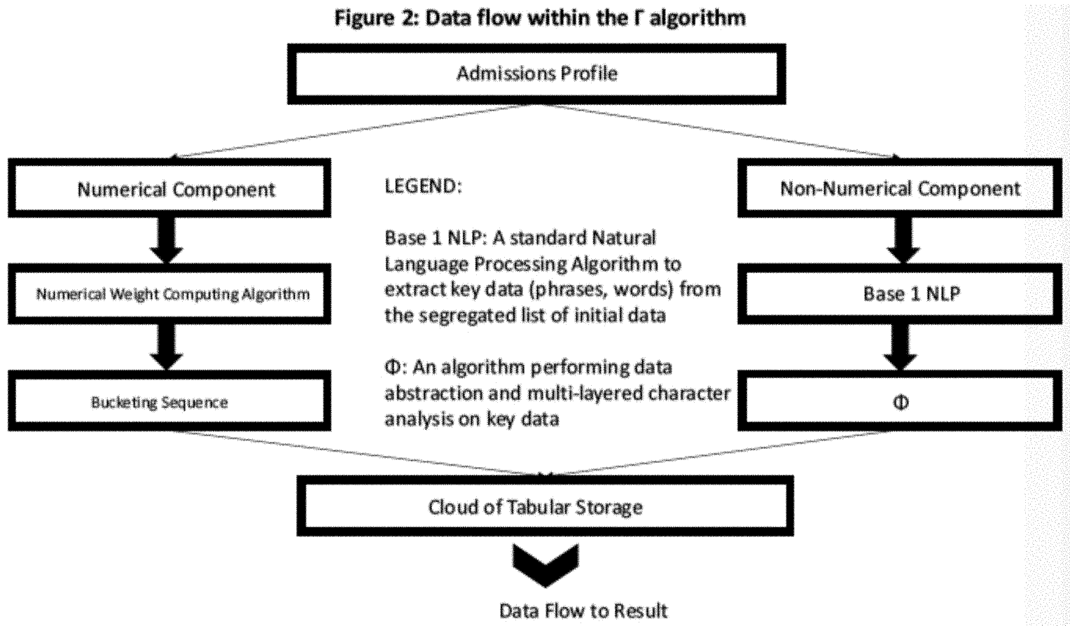

Referencing FIG. 2: The flowchart depicts the specifics of data processing within the Γ algorithm, to give a final of the data report.

Referencing FIG. 2: The admission profile files are run through a parser separating the test scores, examinations and grades files with all the other components. Each separate set of data files (containing its own different components) are evaluated in a separate fashion first.

Referencing FIG. 2: The numerical component is all computed using a formula within the context of the applicants high-school and environment (town, any incidents leading to described performance, and so on) called the ‘Numerical Weight Computing Algorithm’ which uses main numbers such as SAT/ACT scores, SAT Subject Test Scores, GPA's (weighted, unweighted) (or equivalents) and grades/percentages (of any sort with different evaluated boundaries for each internationally situated curriculum), along with trends across years and subjects of the student's academic performance in a complex mathematical formula with lesser weighted variables such as additional factors that may have caused a boost/dip in performance and so on. For example, a similar scoring system is the AI (academic index) system used by Ivy League Institutions in the US to recruit college athletes. This is then bucketed into a similar range of scores decided by the admissions committee (for easy match and access when evaluating this score separately and with the non-numerical component's score). The required, recommended, and non-required sub-component here may/not have different weightages based on user input.

Referencing FIG. 2: The non-numerical component has a Base 1 NLP, which uses ML based enhancement to extract key information separately from the essays, letters of recommendations, extracurriculars, and awards. A standard coreference resolution algorithm will be run on the extracted data, and the keyset result will be processed through a Φ function, one which analyses the meaning, importance, depth, effort (of applicant), and difficulty of each related key set/subset of characters (or phrases and sentences) and computes an array of comprehensive scores and ranges based on the initial entries.

Referencing FIG. 2: This computed set of outputs is stored in a ‘result cloud’ in a tabular fashion, where the tabulated numerals are each assigned to a scorecard aspect that is part of the final result.

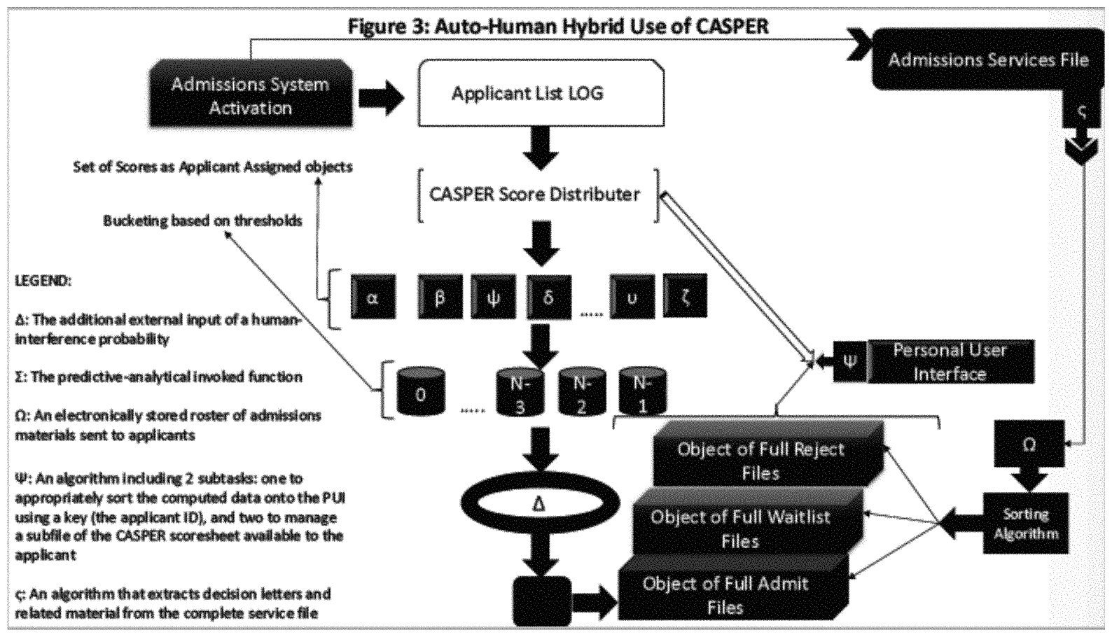

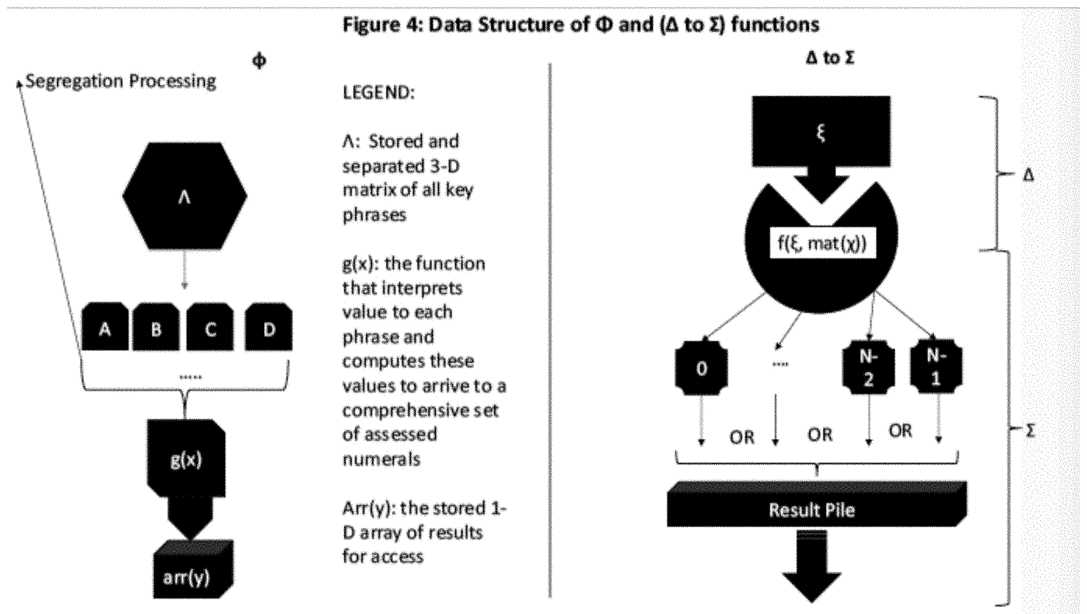

Referencing FIG. 3: The CASPER system is activated by the admissions committee by logging into their service page, which then leads to a linkage of all the files of the applicants, separated by Applicant ID's, which then further is fed into the Γ function leading to the comprehensive CASPER score report.

Referencing FIG. 3: The computed reports are assigned to all applicants back, and a snip-version of it is stored as an encrypted file (only accessible on or after a committee set time before decisions), where the committee decides what part of the CASPER is to be shared with the applicant (done through the ψ function which appropriately pairs the data to the applicant and uses the preset filters from the committee to form the snipped file).

Referencing FIG. 3: The CASPER score distributer then assigns the set of values in a 2-D array back to each applicant (as a 2-D matrix forms an accessible table in each applicant object file). The CASPER score files are then distributed and organized by peculiarity, similarity, data falling in the same range, and so on into 3-Dimensional matrix buckets (to allow for matches in multiple criteria).

Referencing FIG. 3: This classified data (with appropriate keys at each datapoint to the appropriate applicant ID) is halted for a user input of a number between and including 0 and 100 as the A function which interprets numerical ranges as toggles on a meter, amplifying a certain behavior. In this case, the behavior is human interference in final stacking of decisions of applicants, done by the Δ to Σ function. (This function will be described in further detail when referencing FIG. 4.).

Referencing FIG. 3: The final decisions assigned by the function are then assigned appropriately as separate objects of Accept, Reject, and Waitlist decisions, along with any other nuance. The admit files are linked by Applicant ID for appropriate and correct decisions to pop-up on decision day, along with the correctly sorted (by Ω function, and extracted by the ζ function) admission status package from the complete file-set of the Admissions Committee ready for remote user access.

Referencing FIG. 4: In the Φ functionality which is primarily used for non-numerical component evaluation (see FIG. 2), uses a set of simple functions and storage modules for achieving a sub-result. A stored 3-D matrix of all the key strings (containing phrases, words, sentences and so on) (solely for quicker access) is separated according to similar meaning and similar character containing datapoint strings using POS (Part of Speech) tagging, dependency parsing and NER (Named Entity Recognition) as tools to segregate outliers and non-outliers and their previously described subcategories in buckets.

Referencing FIG. 4: These buckets are parsed through a mathematical function assigning values to each passed datapoint, using a database of ‘meaning-match’ strings, strings wherein similarity can be linked to certain other values that are used as part of the function to compute a complete value per matrix position. These value sets are then stored in an array of results for easier access. Correct locational identifiers are used throughout each process to link values back to the initial core phrases.

Referencing FIG. 4: In the Δ to Σ functionality, ξ being a number for 0 to 100 is a parameter to a complex function with the nature f(x,y)m where mat(χ) is the complete multidimensional array (adapting to all the various n number of criteria computer per applicant in the CASPER report (full version)), these 2 parameters are used in the final discerning process of applicant status, where each real number (range) decides a multiplying factor and the choice of complex mathematical function (using a standard switch block) to be used in calculating a final number (which when compared and placed within 3 ranges, decides the admit/reject/waitlist status) all of which is cumulatively stored after segregation in an encrypted temporary cloud of the ‘Result Pile’.

Further command from the committee (electronically leads to a separated result pile by status ready for the committee's viewing which is paired with the appropriate admissions package for all applicants).

Thus, the complete comprehensive complete computer program product can lead to significant advancements in quick and efficient college admissions processes.

While specific ideas and embodiments have been illustrated and described, numerous modifications come to mind without significantly departing from the spirit of the invention, and the scope of protection is only limited by the scope of the accompanying claims.

While certain aspects of the disclosure are presented below in certain claim forms, the inventor contemplates the various aspects of the disclosure in any number of claim forms. For example, while only one aspect of the disclosure is recited as a means-plus-function claim under 35 U.S.C. .sctn.112, 6, other aspects may likewise be embodied as a means-plus function claim, or in other forms, such as being embodied in a computer-readable medium. (Any claims intended to be treated under 35 U.S.C. .sctn.112, 6 will begin with the words “means for”.) Accordingly, the applicant reserves the right to add additional claims after filing the application to pursue such additional claim forms for other aspects of the disclosure.

What is claimed is:

1. A system for admissions predictions, evaluation, and sorting use comprising various processing algorithms to handle and communicate immense admissions related past and current data,
mainly comprising of multiple cloud based services to store raw/semi-processed/processed data from all sources and mobile or non mobile device or non mobile devices and/or another device and mobile or non mobile device admissions file based search app client: and capable of receiving from a user or another device or system, a request to search or calculation for applicant file and applicant status determinations, the request comprising a keyword or multiple keywords or selections or values; based on receiving the request: retrieving, from storage databases, Admissions and applicant status based numerical evaluation and deterministic analysis software engine comprising of;
a data device comprising a plurality of database entries each corresponding to a respective admissions and applicant data related asset (such as non calculated or calculated values or data or metadata or digitized content),
wherein each database entry comprises descriptive metadata associated with the respective admissions and applicant data related asset (such as non calculated or calculated values or data or metadata or digitized content);
comparing, using control circuitry, the keyword or multiple keywords or selections or values to the descriptive metadata associated with each of the plurality of database entries; identifying, based on the comparing, a subset of the plurality of database entries that are associated with the descriptive metadata that includes the keyword or multiple keywords or selections or values,
an application program interface to allow two way communication, interaction and data sharing between the computer program product and other relevant devices or systems,
wherein the subset of the database entries comprises database entries for admissions and applicant data related determinations; and storing, in user or another device or system interaction metadata, the request;
receiving, from the user or another device or system, a selection of the admissions and applicant data related asset (such as non calculated or calculated values or data or metadata or digitized content); based on receiving the selection of the admissions and applicant data related asset (such as non calculated or calculated values or data or metadata or digitized content) storing, in user or another device or system interaction metadata associated with the request, an indication of the selection of the admissions and applicant data related asset; receiving, from the user or another device or system; generating a list of admissions and applicant data related determinations including the admissions and applicant data related asset (such as non calculated or calculated values or data or metadata or digitized content) and
where in the admissions and applicant data related search app client comprises:
software to interact with and present data to a user via the user interface, software to interact with and present data to another device or system interface,
software to retrieve data comprising at least one cloud based service reading from the another cloud based service associated with another device or system interface, software to send the retrieved data from mobile or non mobile device to the admissions and applicant data related determinations search or calculation or calculator engine via the data network interface,
and wherein the system comprises:
wherein the at least one computer processor of at least one of: the mobile or non-mobile device or non mobile device, the admissions and applicant data related determinations search or calculation platform device, or the admissions and applicant data related determinations platform, is configured to: calculate the admissions and applicant data associated attributes;
and wherein the at least one processor is configured to send the admissions and applicant data associated attributes of the device to the admissions and applicant data related determinations search or deterministic evaluation or numero-text based analytical engine via the data network interface, and receive
admissions and applicant data related determinations data at the mobile device or non mobile device or non mobile device for the device, from the admissions and applicant data related determinations search or calculation or calculator engine via the data network interface, and display the admissions and applicant data related determinations data on the user or another device or system interface of the mobile or non-mobile device or non mobile device;
wherein the admissions and applicant data related determinations search or deterministic evaluation or numero-text based analytical engine comprises wherein the at least one computer
processor of the admissions and applicant data related determinations search or calculation platform device is configured to receive the derived or calculated data from the admissions and applicant data related determinations search or deterministic evaluation or numero-text based analytical app client via the data network interface,
send the derived or calculated data to the admissions and applicant data related determinations process parameters determination subsystem computer program product via the data network interface, receive the admissions and applicant data related data from the admissions and applicant data related determinations process parameters determination subsystem via the data network interface, store the derived or calculated data and the admissions and applicant data related determinations data in the admissions and applicant data related determinations search or calculation database, and send the admissions and applicant data related determinations data to the admissions and applicant data related determinations search or deterministic evaluation or numero-text based analytical app client via the data network interface.

2. The system according to claim 1 wherein: the admissions and applicant data related determinations search or deterministic evaluation or numero-text based analytical app is configured to read data from said another cloud service of said plurality of cloud services; wherein the cloud services are encrypted by a known key in the main function of the software.

3. The system according to claim 1 wherein the admissions and applicant data related determinations search or deterministic evaluation or numero-text based analytical engine comprises wherein the at least one computer processor of the admissions and applicant data related determinations search or calculation platform device is configured to calculate the admissions and applicant data related determinations from the received data.

4. The system according to claim 1 wherein: the admissions and applicant data determinations search or deterministic evaluation or numero-text based analytical app client further comprises wherein said at least one computer processor of the mobile device or non mobile device or non mobile device is configured to automatically communicate the admissions and applicant data related determinations data to a pre-configured electronic address.

5. The system according to claim 1 wherein: the admissions and applicant data determinations search or deterministic evaluation or numero-text based analytical app client further comprises wherein said at least one computer processor of the mobile device or non mobile device or non mobile device is configured to display on the user or another device or system interface information regarding the admissions and applicant related determinations data.

6. The system according to claim 1 wherein: the admissions and applicant related determinations search or deterministic evaluation or numero-text based analytical app client further comprises wherein said at least one computer processor of the mobile device or non mobile device or non mobile device is configured to allow the user or another device or system to send the admissions and applicant related determinations data to a user or another device or system-specified electronic address to monitor, manage or control the device.

7. The system according to claim 1 wherein: the admissions and applicant related determinations search or deterministic evaluation or numero-text based analytical app client further comprises wherein said at least one computer processor of the mobile device or non mobile device or non mobile device is configured to display on the user or another device or system interface information regarding the admissions and applicant related determinations data.

8. The system according to claim 1 wherein: complex mathematical and abstract computations with words and processing of adjunct source based and text/raw numeral based data to provide comprehensive scorecards and understandable admissions ranges/strengths/weaknesses/probabilities/and future career or college based profitability (to the college and student) chances available purely by software systems, databases and data structures.

9. A admissions and applicant related determinations client application computer program product embodied on a computer accessible medium configured to execute, on at least one computer processor of a mobile or non mobile device or non mobile device in communication or non communication with a admissions and applicant related determinations search or calculation platform over a communications network, remotely obtaining admissions and applicant related determinations data, comprising:
receiving, by the at least one computer processor, an interaction from a user or another device or system by communicating over data network;
calculating, by the at least one computer processor, admissions and applicant related determinations or value;
incorporating an application program interface to allow two way communication, interaction and data sharing between the computer program product and other relevant devices or systems, wherein the at least one computer processor of the admissions and applicant related determinations search or calculation platform device is configured to receive the derived or calculated data from the admissions and applicant related determinations search or deterministic evaluation or numero-text based analytical app client via the data network interface, send the derived or calculated data to the admissions and applicant related determinations process parameters determination subsystem computer program product via the data network interface, receive the admissions and applicant related determinations data from the admissions and applicant related determinations process parameters determination subsystem via the data network interface, store the derived or calculated data and the admissions and applicant related determinations data in the admissions and applicant related determinations search or calculation database, and send the admissions and applicant related determinations data to the admissions and applicant related determinations search or deterministic evaluation or numero-text based analytical app client via the data network interface;
For responding, by the at least one computer processor, to the user or another device or system interaction by reading cloud based service readings from another cloud based service of said plurality of cloud based services; wherein the cloud based services connected to databases, or cloud based services connected to other admissions, and another cloud based service, other than a touchscreen, a keyboard, and a mouse; forming, by the at least one computer processor, a admissions and applicant related determinations search or calculation request by inserting, by the at least one computer processor, the cloud based service readings from the plurality of cloud based services into the admissions and applicant related determinations search or calculation request; and sending, by the at least one computer processor, the admissions and applicant related determinations search or calculation request, over the communications network, to the admissions and applicant related determinations search or calculation platform;
and receiving, by the at least one computer processor, admissions and applicant related determinations data, from the communications network, in response to the admissions and applicant related determinations search or calculation request; and
wherein the method comprises: retrieving, by the at least one computer processor, data comprising the at least one cloud based service reading; and calculating, by the at least one computer processor, admissions and applicant related determinations or values.

10. A method, comprising various processing algorithms to handle and communicate immense admissions data, on a mobile or non mobile device or non mobile devices and/or another device: capable of receiving from a user or another device or system, a request to search or calculation for admissions and applicant related determinations, the request comprising a keyword or multiple keywords or selections or values; based on receiving the request: retrieving, from storage circuitry, communicating with a data device comprising a plurality of database entries each corresponding to a respective admissions and applicant related asset (such as non calculated or calculated values or data or metadata or digitized content) wherein each database entry comprises descriptive metadata associated with the respective admissions and applicant related asset; comparing, using control circuitry, the keyword or multiple keywords or selections or value to the descriptive metadata associated with each of the plurality of database entries; identifying, based on the comparing, a subset of the plurality of database entries that are associated with the descriptive metadata that includes the keyword or multiple keywords or
selections or values,
wherein the subset of the database entries comprises database entries for admissions and applicant related determinations; and storing, in user or another device or system interaction metadata, the request; receiving, from the user or another device or system, a selection of the admissions and applicant related asset; based on receiving the selection of the admissions and applicant related asset (such as non calculated or calculated values or data or metadata or digitized content) storing, in user or another device or
system interaction metadata associated with the request, an indication of the selection of the admissions and applicant related asset; receiving, from the user or another device or system; generating a list of admissions and applicant related determinations including the admissions and applicant related asset (such as non calculated or calculated values or data or metadata or digitized content) and wherein the system comprises: wherein the at least one computer processor of at least one of: the mobile or non-mobile device or non mobile device, the admissions and applicant related determinations search or calculation platform device, or the admissions and applicant related determinations platform, is configured to: calculate the admissions and applicant related or associated attributes; and wherein the at least one processor is configured to send the admissions and applicant related or associated attributes of the device to the admissions and applicant related determinations search or deterministic evaluation or numero-text based analytical engine via the data network interface, and receive admissions and applicant related determinations data at the mobile device or non mobile device or non mobile device for the device, from the admissions and applicant related determinations search or deterministic evaluation or numero-text based analytical engine via the data network interface, and display the admissions and applicant related determinations data on the user or another device or system interface of the mobile or non-mobile device or non mobile device;
wherein the admissions and applicant related determinations search or deterministic evaluation or numero-text based analytical engine comprises wherein the at least one computer processor of the admissions and applicant related determinations search or calculation platform device is configured to receive the derived or calculated data from the admissions and applicant related determinations search or deterministic evaluation or numero-text based analytical app client via the data network interface, send the derived or calculated data to the admissions and applicant related determinations process parameters determination subsystem computer program product via the data network interface, receive the admissions and applicant related determinations data from the admissions and applicant related determinations process parameters determination subsystem via the data network interface, store the derived or calculated data and the admissions and applicant related determinations data in the admissions and applicant related determinations search or calculation database, and send the admissions and applicant related determinations data to the admissions and applicant related determinations search or deterministic evaluation or numero-text based analytical app client via the data network interface.

11. The method according to claim 8 wherein: the admissions and applicant related determinations search or deterministic evaluation or numero-text based analytical app is configured to read data from said another cloud based service of said plurality of cloud based services; wherein the cloud based services connected to databases and 3rd party sources, or cloud based services connected to other admissions.

12. A set of methods in accordance to claim 8 having detailed aspects wherein:
i. The method according to claim 8 wherein at least one computer processor of the admissions and applicant related determinations search or calculation platform device is configured to calculate the admissions and applicant related determinations from the received data.
ii. The method according to claim 8 wherein: the admissions and applicant related determinations search or deterministic evaluation or numero-text based analytical app client of the mobile device or non mobile device or non mobile device is configured to automatically communicate the admissions and applicant related determinations data to a pre-configured electronic address.
iii. The method according to claim 8 wherein: the admissions and applicant related determinations search or deterministic evaluation or numero-text based analytical app client of the mobile device or non mobile device or non mobile device is configured to allow the user or another device or system to send the admissions and applicant related determinations data to a user or another device or system-specified electronic address to monitor, manage or control the device.
iv. The method according to claim 8 wherein: the admissions and applicant related determinations search or deterministic evaluation or numero-text based analytical app client of the mobile device or non mobile device or non mobile device is configured to display on the user or another device or system interface information regarding the admissions and applicant related determinations data.

13. Characteristics of the computer program product in the core function involving:
i. A computer program product involving: multiple layers and dimensions of sorting, classifying, pre-processing and associating of initial data and suggestive data along with other related inputs along the data flow of the software algorithm functionality.
ii. A computer program product involving: complex flows (with switch-case, split function, multi-storage, statistical and NLP (enhanced with ML) based standard algorithms) and invoking of data along the activation and result display processes of the software system, wherein data is processed to provide various aptitudes of understanding the applicant data in context of multiple fields.
